(19) United States
(12) Patent Application Publication
(10) Pub. No.: US 2023/0410807 A1
(43) Pub. Date: Dec. 21, 2023

(54) DIALOGUE EVALUATION METHOD, DIALOGUE EVALUATION APPARATUS AND PROGRAM

(71) Applicant: NIPPON TELEGRAPH AND TELEPHONE CORPORATION, Tokyo (JP)

(72) Inventors: Yoko TOKUNAGA, Tokyo (JP); Takeshi KURASHIMA, Tokyo (JP); Hiroyuki TODA, Tokyo (JP)

(21) Appl. No.: 18/251,082

(22) PCT Filed: Nov. 10, 2020
(86) PCT No.: PCT/JP2020/041946

§ 371 Date: Apr. 28, 2023

(51) Int. Cl. G10L 15/22

(52) U.S. Cl. CPC G10L 15/22

(57) ABSTRACT

A computer executes a first calculation procedure of calculating a first score regarding personality characteristics of a participant based on a questionnaire result for the participant in a group dialogue, a second calculation procedure of calculating a second score regarding an activity level of the participant in the group dialogue based on data in which contents of the group dialogue is recorded, and a third calculation procedure of calculating a third score indicating evaluation on the group dialogue by the participant based on the first score and the second score, thereby improving estimation accuracy of evaluation by each participant for the group dialogue.

### TECHNICAL FIELD

The present invention relates to a dialogue evaluation method, a dialogue evaluation device, and a program.

### BACKGROUND ART

Dialogues include group dialogues conducted between people and system dialogues conducted between dialogue systems and people. For evaluation in a group dialogue, there is a technology of estimating the leadership or the degree of contribution from the frequency of words included in the uttered sentences during the dialogue, the number of nods that can be distinguished in the camera video image, and the like (for example, Non Patent Literature 1). In addition, there are a method of performing questionnaire evaluation such as how much the participants were able to directly contribute or whether the participants were satisfied, a method of causing a third party to evaluate the deliverables of the dialogue, and the like (for example, Non Patent Literature 2). In the case of evaluating a dialogue by a dialogue system, there is a technology of evaluating a sentence generated by the system (for example, Patent Literature 1).

### CITATION LIST

### Patent Literature

Patent Literature 1: JP 2016-45769 A

### Non Patent Literature

Non Patent Literature 1: A Multimodal-Sensor-Enabled Room for Unobtrusive Group Meeting Analysis, Bhattacharya et al., 2018
Non Patent Literature 2: Bot in the Bunch: Facilitating Group Chat Discussion by Improving Efficiency and Participation with a Chatbot, Kim et al., 2020

### SUMMARY OF INVENTION

### Technical Problem

The personality characteristics of each participant affect the evaluation of a dialogue. For example, even with the same number of utterances, there is a difference that a talkative person may consider that the utterances have been insufficient and the person was not able to sufficiently contribute, and an introverted person may have talked more than usual and feel a sense of achievement. Therefore, it is possible to perform evaluation indicating the true degree of achievement, the degree of satisfaction, and the degree of contribution to the dialogue by considering the personality characteristics and the behavior in the actual dialogue together.

In Patent Literature 1, the personality characteristics of a dialogue participant and a behavior in the dialogue are not considered. In Non Patent Literature 1, a behavior in the dialogue such as an uttered sentence and a camera video image is considered, but the personality characteristics of the participants are not considered. In Non Patent Literature 2, a behavior in the dialogue in text of the message is considered, but the personality characteristics of the participants are not considered. In addition, the questionnaire evaluation in Non Patent Literature 2 is to evaluate how effective the chatbot was, and is not to evaluate the dialogue itself. In the evaluation of the deliverables, it may not be possible to evaluate a process in which the deliverables were obtained, such as whether each participant was satisfied with the contents or whether all the participants have contributed to the consensus building.

The present invention has been made in view of the above points, and an object of the present invention is to improve estimation accuracy of evaluation by each participant regarding group dialogue.

### Solution to Problem

In order to solve the above problem, a computer executes a first calculation procedure of calculating a first score regarding personality characteristics of a participant based on questionnaire results for the participant in a group dialogue, a second calculation procedure of calculating a second score regarding an activity level of the participant in the group dialogue based on data in which contents of the group dialogue is recorded, and a third calculation procedure of calculating a third score indicating an evaluation of the group dialogue by the participant based on the first score and the second score.

### Advantageous Effects of Invention

It is possible to improve the estimation accuracy of the evaluation by each participant for a group dialogue.

### BRIEF DESCRIPTION OF DRAWINGS

FIG. 1 is a diagram illustrating a hardware configuration example of a dialogue evaluation device 10 according to an embodiment of the present invention.

FIG. 2 is a diagram illustrating a functional configuration example of the dialogue evaluation device 10 according to the embodiment of the present invention.

FIG. 3 is a flowchart for describing an example of a processing procedure executed by the dialogue evaluation device 10.

### DESCRIPTION OF EMBODIMENTS

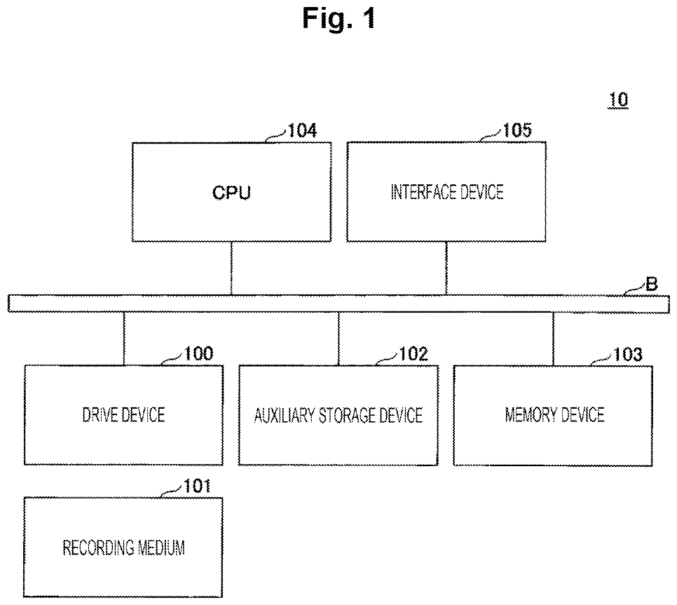

Hereinafter, an embodiment of the present invention will be described with reference to the drawings. FIG. 1 is a diagram illustrating a hardware configuration example of a dialogue evaluation device 10 according to the embodiment of the present invention. The dialogue evaluation device 10 in FIG. 1 includes a drive device 100, an auxiliary storage device 102, a memory device 103, a CPU 104, an interface device 105, and the like which are connected to each other by a bus B.

A program for realizing processing in the dialogue evaluation device 10 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101 and may be downloaded from another computer via a network. The auxiliary storage device 102 stores the installed program and also stores necessary files, data, and the like.

When an instruction to start the program is issued, the memory device 103 reads the program from the auxiliary storage device 102 and stores the program. The CPU 104 executes a function related to the dialogue evaluation device 10 according to the program stored in the memory device 103. The interface device 105 is used as an interface for connecting to a network.

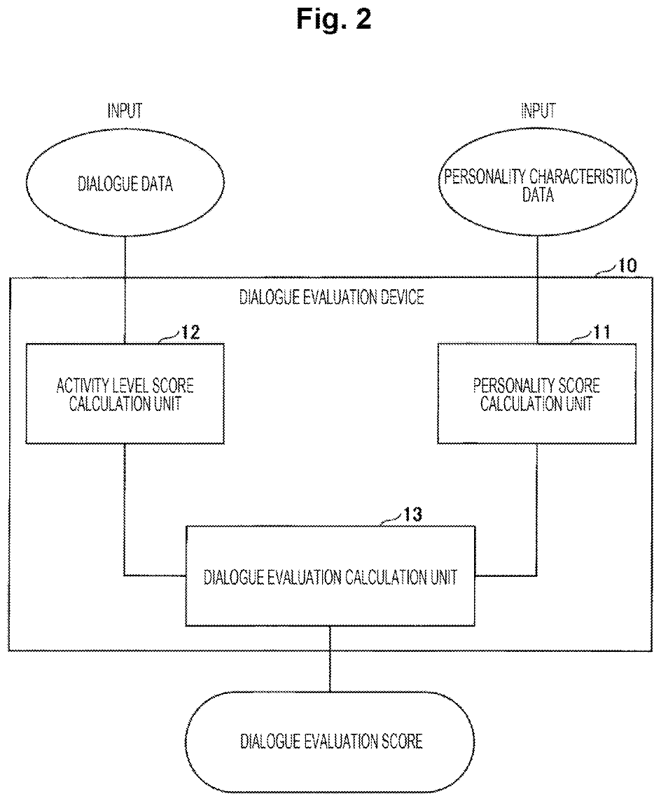

FIG. 2 is a diagram illustrating a functional configuration example of the dialogue evaluation device 10 according to the embodiment of the present invention. As illustrated in FIG. 2, the dialogue evaluation device 10 includes a personality score calculation unit 11, an activity level score calculation unit 12, and a dialogue evaluation calculation unit 13 in order to estimate a score obtained by quantifying the evaluation reflecting the degree of achievement, the degree of satisfaction, the degree of contribution, and the like of each participant with respect to the group dialogue (hereinafter, referred to as “target dialogue”) performed by a plurality of participants. Each of these units is realized by processing that one or more programs installed in the dialogue evaluation device 10 cause the CPU 104 to execute.

In the present embodiment, the number of participants of the target dialogue is N, and each participant is expressed by h₁, h₂, . . . , and h_{N}.

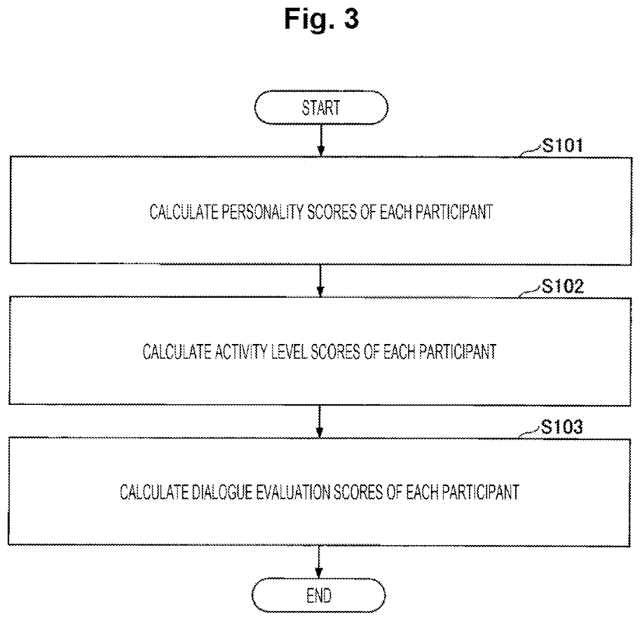

FIG. 3 is a flowchart for describing an example of a processing procedure executed by the dialogue evaluation device 10.

In step S101, the personality score calculation unit 11 uses the personality characteristic data of each participant as an input, and calculates the personality score of each participant based on each piece of personality characteristic data.

The personality characteristic data is data representing the personality characteristics of the participant, and is stored in advance in the auxiliary storage device 102, for example. For example, the personality characteristic data is generated based on questionnaire results obtained by conducting a questionnaire to each participant in advance. In the content of the questionnaire, for example, in response to a question “I like to talk about myself in front of people.”, each participant is caused to select a corresponding one from options such as “I think like that.”, “I think like that a little bit.”, “I do not think like that that much.”, and “I do not think like that at all.”, or each participant is caused to select a corresponding one from options of words such as “silent”, “talkative”, and “extroverted”.

The personality characteristic data is obtained by quantifying answers of the questionnaire as described above. For example, the data is data in which numerical values of a plurality of stages (for example, 9 stages and the like) are assigned to options of questions and answers and the data includes which answer is selected by each participant. When the answer is a question answered as Yes or No, Yes may be quantified as 1 and No may be quantified as 0. In addition, questions with different answer options such as a question answered as Yes or No and a question answered in a plurality of stages may be mixed.

Here, it is assumed that M questions are asked to each participant as a questionnaire. For each question, weights are q₁, q₂, . . . , q_{M}. It is assumed that answers to each question of the questionnaire of the participant hᵢ are aᵢ₁, aᵢ₂, . . . , a_{iM}. In this case, the personality characteristic data includes an answer aᵢ to each question and a weight q for each participant hᵢ.

The personality score calculation unit 11 calculates the personality score Pᵢ of the participant i as follows based on such personality characteristic data.

$$\begin{matrix}[ Mathematical formula 1 ] & \\ {P}_{i} = {\sum }_{k = 1}^{M} {q}_{k} {a}_{ik} & ( 1 )\end{matrix}$$

Note that the personality score is not limited to one including one numerical value (that is, the scalar value), and may be expressed by a vector. It is also considered that 5 questions among the 10 questions of the questionnaire are designed as questions of personality characteristics A, and the remaining 5 questions are designed as questions of personality characteristics B, and the personality score is expressed by a two-dimensional vector having an average of each of the two types as an element. The personality characteristics A and B mentioned here may be two types of scales representing the same personality characteristics or may be scales representing two different personality characteristics. In either case of the scalar value and the vector, what the magnitude of the numerical value represents depends on the design of the questionnaire, and details are not limited as long as the personality characteristics is represented. For example, when a questionnaire includes a question regarding extroversion or introversion, the personality score will be a numerical value (or vector) that includes the degree of extroversion or introversion. Furthermore, when a question regarding the cooperativity is included in the questionnaire, the personality score is a numerical value (or vector) including the presence or absence of the cooperativity. The personality score may be a relative value as long as differences in personality characteristics between participants can be distinguished.

The personality score calculation unit 11 inputs the personality score Pᵢ of each participant, which is a calculation result, to the dialogue evaluation calculation unit 13.

Subsequently (or together with step S101), the activity level score calculation unit 12 uses the dialogue data of the target dialogue as an input, and calculates a score (hereinafter referred to as “activity level score”) indicating the activity level of the dialogue for each participant based on the dialogue data (S102).

The dialogue data is data in which the entire target dialogue is recorded in time series, and is stored in the auxiliary storage device 102, for example. Examples of the dialogue data include voice data collected by a microphone, text data in which contents uttered by each member are written, video data in which movement of each member is captured, and vital data in which vital data such as a heartbeat of each member is recorded using a device such as a smart watch.

In addition, the activity level of the dialogue is an index indicating how much the dialogue is excited or uplifting feeling of the participants. In the case of the voice data, the size, change, and utterance frequency of voices of each participant can be used as the activity level. In the case of the text data, the number of utterances, the length of utterance, and the meaning and frequency of appearance of a word included in the utterance of each participant can be used as the activity level. In the case of the video data, the size of gesture or the size of nod can be used as the activity level. In the case of the vital data, the speed or change of heartbeat can be used as the activity level.

Here, an example of a case where the voice data of the participant is used as the dialogue data will be described. The activity level score calculation unit 12 extracts the following two feature quantities from the dialogue data.

Utterance frequency of each participant (number of times) T₁, . . . , T_{N}

Average voice volume (average volume) V₁, . . . , V_{N} of each participant at the time of utterance

The utterance frequency (number of times) of each participant can be extracted based on the voice separated for each participant by separating the voice recorded in the voice data for each participant. Note that regarding the voice in the voice data, separation for each participant (for each speaker) can be performed using a known technology. The average voice volume (average volume) at the time of the utterance of each participant can also be extracted based on the voice separated for each participant.

Note that the feature quantity may be extracted from the dialogue data other than the voice data. For example, the utterance frequency (the number of times) of each participant may be calculated by analyzing video data obtained by capturing the target dialogue. The average voice volume (average volume) at the time of the utterance of each participant may be calculated based on the voice collected for each microphone with a microphone attached to each participant.

The activity level score calculation unit 12 calculates the activity level score of the participant hᵢ based on these feature quantities as follows. The activity level score of the dialogue of the participant hᵢ is expressed as follows.

Eᵢ=W_{T}Tᵢ+W_{V}Vᵢ (2)

Here, W_{T} is a weight for the utterance frequency, and W_{V} is a weight for the voice volume.

Note that, similarly to the personality score, the activity level score may be a value that can be relatively evaluated among the participants. That is, when the activity level is different, the activity level score may be different.

In the above example, only the utterance frequency and the voice volume of the participant hᵢ himself or herself are used as the feature quantity used for the activity level score of the participant hᵢ, but a feature representing the behavior of the dialogue of another participant participating in the same dialogue may be used for calculating the activity level score of the participant hᵢ. In addition, a statistical numerical value such as an average of the number of utterances or a ratio to the number of utterances of all participants may be used, or external data such as a meaning or a category of a word included in the utterance may be combined. Furthermore, in a case where the dialogue data includes information regarding the time of the dialogue, a change in the feature for each time may be reflected in the activity level score. Similarly to the personality score, the activity level score may also be expressed by a vector. In a case where the activity level score is expressed by a vector, for example, it is considered that (A) the time range in which the utterance frequency is calculated is different for each dimension of the vector, such as the utterance frequency in the entire dialogue, and the utterance frequency within a specific time (such as an interval of 10 minutes), and (B) each dimension, such as the utterance frequency at time t1 and the utterance frequency at time t2 when all dialogues are divided at 10-minute intervals, is the utterance frequency in each time area. Furthermore, it is also considered that (C) the dimensions are divided according to the speaker, such as the utterance frequency by the person in question and the average of the utterance frequencies of the other three people. In addition, it is also considered that the first half a dimension is the feature quantity of (A), the next @ dimension is the feature quantity of (B), and the remaining y dimension is the feature quantity of (C) by combining these dimensions.

The activity level score calculation unit 12 inputs an activity level score for each participant, which is a calculation result, to the dialogue evaluation calculation unit 13.

Subsequently, the dialogue evaluation calculation unit 13 calculates the dialogue evaluation score for each participant based on the personality score of each participant and the activity level score of each participant (S103).

The dialogue evaluation score is a score indicating evaluation by the participant regarding the degree of achievement, the degree of satisfaction, or the degree of contribution of the participant to the target dialogue. The dialogue evaluation calculation unit 13 calculates the dialogue evaluation score Sᵢ of the participant hᵢ as follows.

Sᵢ=PᵢEᵢ (3)

As long as the personality score and the activity level score are used as the dialogue evaluation score, the calculation method is not limited thereto. For example, the weights of the personality score and the activity level score may be calculated as W_{P} and W_{E} as follows.

Sᵢ=W_{P}PᵢW_{E}Eᵢ (3′)

When Pᵢ and Eᵢ are vectors, Sᵢ is also a vector. Alternatively, a value converted into a scalar value by an inner product may be Sᵢ.

Note that the dialogue evaluation calculation unit 13 may calculate the dialogue evaluation score of the entire group by calculating an average or the like of the dialogue evaluation scores of the respective participants.

As described above, according to the present embodiment, in the evaluation of the group dialogue, the dialogue evaluation score is calculated based on the personality score calculated from the personality characteristic data indicating the personality characteristics of each participant and the activity level score calculated from the dialogue data in which the dialogue is recorded. As a result, it is possible to improve the estimation accuracy of the evaluation indicating the degree of contribution, the degree of satisfaction, and the degree of achievement of each participant. That is, it is possible to improve the estimation accuracy of the evaluation by each participant for the group dialogue.

Furthermore, from the estimated evaluation, it is possible to consider the grouping according to the dialogue agenda and the environment. For example, in the education field, regardless of whether a child has high aggressiveness or low aggressiveness, the child can utter in the group and whether or not the child has been able to contribute to the consensus building can be determined from the dialogue evaluation score, which can be useful for the consideration of changing the configuration of the group according to the personality characteristics.

Furthermore, in a case where it is desired to repeatedly perform a dialogue by a plurality of persons over a long period of time, in order to maintain motivation, the degree of satisfaction with the dialogue of each participant may be regarded as important more than the quality of the deliverables, and the dialogue evaluation score obtained by the present embodiment can be used as an important determination material at the time of subsequent grouping.

In the present embodiment, the personality score is an example of the first score. The activity level score is an example of the second score. The dialogue evaluation score is an example of a third score. The personality score calculation unit 11 is an example of a first calculation unit. The activity level score calculation unit 12 is an example of a second calculation unit. The dialogue evaluation calculation unit 13 is an example of a third calculation unit.

Although the embodiments of the present invention have been described in detail above, the present invention is not limited to such specific embodiments, and various modifications and changes can be made within the scope of the gist of the present invention described in the claims.

### REFERENCE SIGNS LIST

10 Dialogue evaluation device
11 Personality score calculation unit
12 Activity level score calculation unit
13 Dialogue evaluation calculation unit
100 Drive device
101 Recording medium
102 Auxiliary storage device
103 Memory device
104 CPU
105 Interface device
B Bus

1. A dialogue evaluation method executed by a computer including a memory and a processor, the dialogue evaluation method comprising:
calculating a first score regarding personality characteristics of a participant based on questionnaire results for the participant in a group dialogue,
calculating a second score regarding an activity level of the participant in the group dialogue based on data in which contents of the group dialogue is recorded, and
calculating a third score indicating an evaluation of the group dialogue by the participant based on the first score and the second score.

2. The dialogue evaluation method according to claim 1, wherein, the second score is calculated based on an utterance frequency of the participant and the volume at the time of the utterance of the participant.

3. The dialogue evaluation method according to claim 1, wherein an average of the third scores for each participant in the group dialogue is further calculated.

4. A dialogue evaluation device comprising:
a memory; and
a processor configured to execute
calculating a first score regarding personality characteristics of a participant based on questionnaire results for the participant in a group dialogue,
calculating a second score regarding an activity level of the participant in the group dialogue based on data in which contents of the group dialogue is recorded, and
calculating third score indicating an evaluation of the group dialogue by the participant based on the first score and the second score.

5. The dialogue evaluation device according to claim 4, wherein the second score is calculated based on an utterance frequency of the participant and the volume at the time of the utterance of the participant.

6. The dialogue evaluation device according to claim 4, wherein an average of the third scores for each participant in the group dialogue is further calculated.

7. A non-transitory computer-readable recording medium having computer-readable instructions stored thereon, which when executed, cause a computer to execute the dialogue evaluation method according to claim 1.
